(19) United States
(12) Patent Application Publication
(10) Pub. No.: US 2009/0179764 A1
(43) Pub. Date: Jul. 16, 2009

(54) Device For Detecting Passenger's Weight In Vehicle

(76) Inventors: Chul-Sub Lee, Daegu (KR); Young-Deok Kim, Seoul (KR); Jin-Kwang Kim, Kyung-Nam (KR)

Correspondence Address: BARLEY SNYDER, LLC, 1000 WESTLAKES DRIVE, SUITE 275, BERWYN, PA, 19312, US

(21) Appl. No.: 12/354,464

(22) Filed: Jan. 15, 2009

(30) Foreign Application Priority Data
Jan. 15, 2008 (KR) 10-2008-0004400
Feb. 5, 2008 (KR) 10-2008-0011581
Dec. 9, 2008 (KR) 10-2008-0124805

(51) Int. Cl. G08B 21/00

(52) U.S. Cl. 340/667

(57) ABSTRACT

The passenger weight detection device includes a sensor body including a center hole, fixing holes formed on the center hole, and a mounting recess formed in the sensor body to mount a diaphragm. Additionally, a semiconductor strain gauge is attached to the diaphragm and a printed circuit board (PCB) is built in the mounting recess of a flange and extended from the center hole, thereby being electrically connected with the semiconductor strain gauge. The passenger weight detection device further includes a semiconductor chip, a connector, a cutaway part formed between the center hole and the fixing holes, and an under cover made of metal to close exposed parts of the center hole and the mounting recess.

### CROSS-REFERENCE TO RELATED APPLICATIONS

This application claims the benefit of the filing date under 35 U.S.C. §119(a)-(d) of Korean Patent Application No. 10-2008-0004400, filed Jan. 15, 2008, Korean Patent Application No. 10-2008-0011581, filed Feb. 5, 2008, and Korean Patent Application No. 10-2008-0124805, filed Dec. 9, 2008.

### FIELD OF THE INVENTION

The present invention relates to a device for detecting a passenger's weight in a vehicle, and more particularly to a passenger weight detection device capable of preventing a fastening force, generated when a sensor body is connected to a seat rail of the vehicle, from directly affecting a diaphragm of the sensor body fastened to a seat frame of the vehicle.

### BACKGROUND

Recently, vehicle airbags have been installed not only for drivers, but also for passengers. Deployment of the airbag is being restricted in accordance with conditions and measurements of the passenger.

Such conditions restrict the deployment of the airbag, which include actual presence of a passenger in the passenger seat, a measured weight of the passenger, etc. A device that can accurately detect and measure the passenger's weight is essential. An electronic control unit (ECU) receives information on the passenger's weight from a passenger weight detection device, as well as other information from other devices, thereby deciding whether to deploy an airbag associated with the passenger seat according to a predetermined deployment range of the airbag.

A conventional passenger weight detection device is structured in such a manner that a thin foil film strain gauge is attached to a simple metal member to measure variation of a strain at a surface of the metal member, and accordingly detects the passenger's weight.

However, in the above sensor structure, unless the sensor is properly designed, the sensor may operate too sensitively, measuring every miscellaneous load. In other words, it is difficult to precisely measure only the vertical load applied by the passenger, that is, the passenger's weight.

To this end, recently, sensors and strain gauges are being structurally improved to optimally filter miscellaneous loads, yet generate sensor outputs only with respect to a weight load exerted in a measurement direction. A typical example of such a configuration is a full bridge circuit constituted by a diaphragm and four strain gauges. According to this configuration, selectivity of the sensor is improved, that is, miscellaneous loads can be more efficiently filtered. Furthermore, sensitivity and temperature compensation efficiency of the sensor can be enhanced.

In addition, by applying a semiconductor-type strain gauge having a great factor, appropriate sensitivity can be maintained and desired strength of the sensor structure can be obtained.

FIG. 1 shows a “passenger weight detection device for vehicle” according to a conventional art which is filed by the present applicant. The passenger weight detection device comprises a sensor body 11 that is constituted by a center hole 111, fixing holes 112, each having an inner screw thread (not shown) and being formed at both sides of the center hole 111, and a mounting recess 114 formed at an inside of the sensor body 11 to mount a diaphragm 113 along an outer circumference of the center hole 111.

Additionally, a semiconductor strain gauge 12 is attached to the diaphragm 113, which is mounted in the sensor body 11, to detect a vertical load. A printed circuit board (PCB) 13 is built in the mounting recess 114 formed at the outside of a flange 111A extended downward from the center hole 111 (upward in the drawing), and electrically connected with the semiconductor strain gauge 13. The passenger weight detection device further includes a semiconductor chip 13A and a connector 14, which are in electric connection with the PCB 13.

According to the conventional passenger weight detection device, however, the center hole 111 of the sensor body 11 is directly connected to a seat rail of the vehicle using bolts. Therefore, the diaphragm 113, which is attached with the semiconductor strain gauge 12, is directly affected by a fastening force of the bolts. In cases where the fastening force of the bolts is varied, a difference of the force transmitted to the diaphragm 113 may occur during mounting, even though a reference output value at the beginning of the mounting needs to be constantly maintained. As a result, accuracy and reliability of the detection are not maintained.

Furthermore, in the conventional passenger weight detection device, the fixing holes 112 formed at both sides of the sensor body 11 are also fastened to a seat frame of the vehicle using bolts. Therefore, lateral load and other miscellaneous loads, such as the moment that is generated by flatness and bending of the seat frame, and difference in parallelism between the seat frame and a seat rail disposed above the seat frame, would directly affect the diaphragm through the sensor body. Therefore, accuracy and reliability of the detection is not well maintained or achieved.

### SUMMARY

Therefore, the present invention has been made in view of the above problems, and it is an object of the present invention to provide a passenger weight detection device for a vehicle, capable of preventing any fastening force, which is generated when a sensor body is connected to a seat rail of the vehicle, from directly affecting a diaphragm of the sensor body fastened to a seat frame of the vehicle. Additionally, such a device assists in preventing a lateral load and other miscellaneous loads including the moment from directly affecting the diaphragm through fixing holes formed on both sides of the sensor body.

The passenger weight detection device includes a sensor body including a center hole, fixing holes formed on the center hole, and a mounting recess formed in the sensor body to mount a diaphragm. Additionally, a semiconductor strain gauge is attached to the diaphragm and a printed circuit board (PCB) is built in the mounting recess of a flange and extended from the center hole, thereby being electrically connected with the semiconductor strain gauge. The passenger weight detection device further includes a semiconductor chip, a connector, a cutaway part formed between the center hole and the fixing holes, and an under cover made of metal to close exposed parts of the center hole and the mounting recess.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a bottom perspective view of a conventional passenger weight detection device for a vehicle;

FIG. 2 and FIG. 3 are views illustrating a passenger weight detection device according to a first embodiment of the present invention, and more particularly,

FIG. 2 is a perspective view showing the structure of a sensor body;

FIG. 3 is a half-sectional perspective view of the sensor body;

FIG. 4 is an exploded perspective view showing a passenger weight detection device according to a second embodiment of the present invention;

FIG. 5 is a sectional view showing an assembled state of FIG. 4;

FIG. 6 is a sectional view showing a passenger weight detection device according to a third embodiment of the present invention;

FIG. 7 and FIG. 8 are views illustrating a passenger weight detection device according to a fourth embodiment of the present invention, and more particularly,

FIG. 7 is a sectional view; and

FIG. 8 is an exploded perspective view.

### DETAILED DESCRIPTION OF THE EMBODIMENT(S)

Hereinafter, exemplary embodiments of the present invention will be described in detail with reference to the accompanying drawings. It is noted that various modified configurations of the embodiment can be included in the scope of the present invention. The following description is provided to explain the present invention more specifically to the generally-known in the art. Therefore, respective elements of the embodiment may be exaggerated in the drawings.

In the same manner as a conventional device explained hereinbefore, a passenger weight detection device according to one embodiment of the present invention includes a sensor body 11 constituted by a center hole 111, fixing holes 112. Each fixing hole 112 includes an inner screw thread 112A and are disposed at both sides of the center hole 111. The sensor body 11 further includes a mounting recess 114 formed at an inside of the sensor body 11 to mount a diaphragm 113 along an outer circumference of the center hole 111.

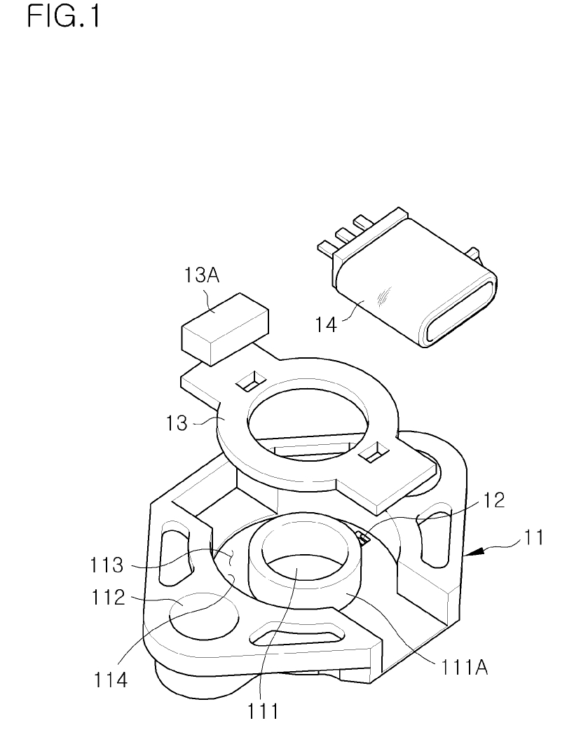

In addition, a semiconductor strain gauge 12 is attached to the diaphragm 113, which is mounted in the sensor body 11, in order to detect a vertical load. A printed circuit board (PCB) 13 is built in the mounting recess 114 formed at the outside of a flange 111A extended downward from the center hole 111, and electrically connected with the semiconductor strain gauge 13. The passenger weight detection device further comprises a semiconductor chip 13A and a connector 14, which are electrically connected with the PCB 13. (refer to FIG. 1)

The center hole 111 of the sensor body 11 is fastened to a seat rail (not shown) of a vehicle seat, and the fixing holes 112 formed at both sides of the center hole 111 are fastened to a seat frame using bolts. Outsides of the PCB 13 and the semiconductor chip 13A are molded by epoxy resin in a mounting hole 110 and the center hole 111.

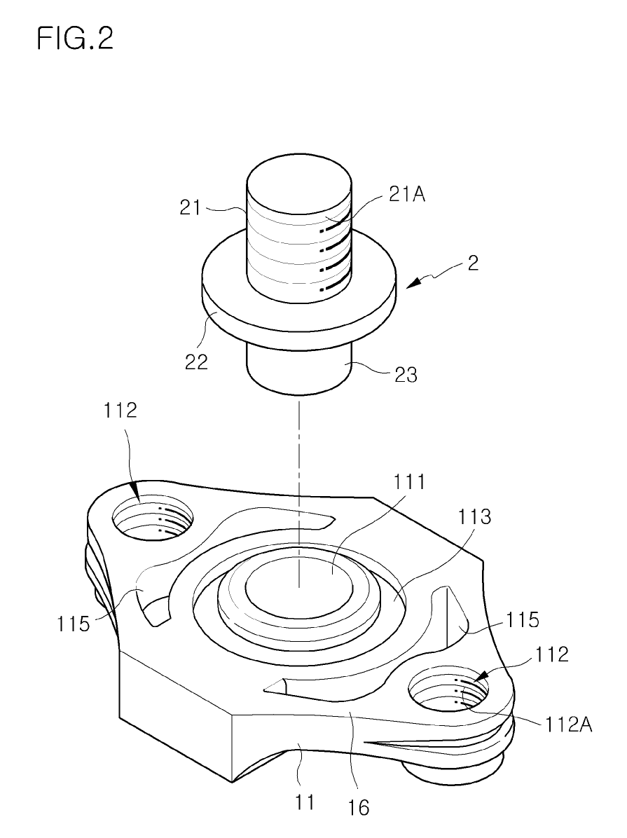

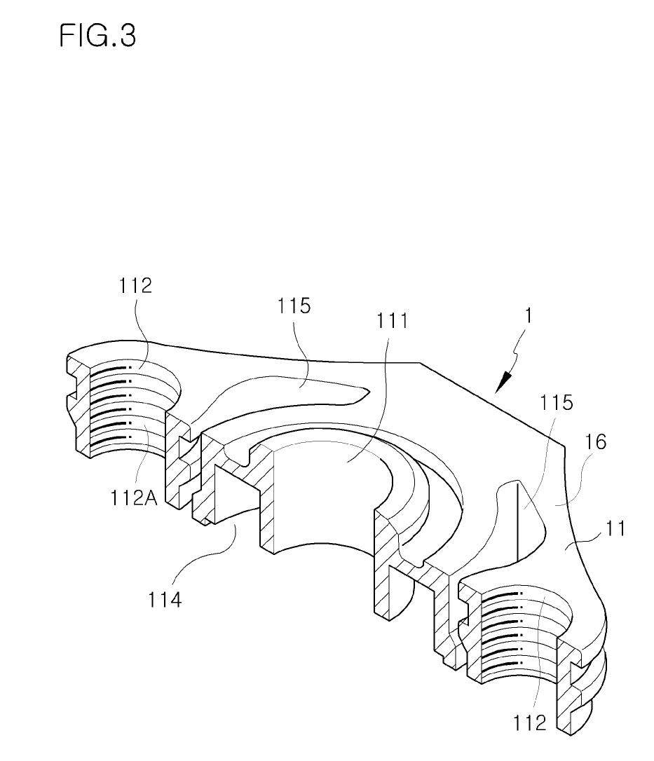

In the above structured passenger weight detection device according to the embodiment of the present invention, as shown in FIG. 2 and FIG. 3, a cutaway part 115 is further formed between the center hole 111 and each of the fixing holes 112 of the sensor body 11.

By forming the cutaway part 115 between the center hole 111 and the fixing holes 112, a lateral load and other miscellaneous loads including the moment can be prevented from being transmitted to the diaphragm 113, which is mounted with the semiconductor strain gauge, through the sensor body 11 and the fixing holes 112 having the inner screw threads 112A.

In addition, a bolt shaft 2 is vertically formed in the center hole 111 of the sensor body 11. More specifically, the bolt shaft 2 includes a connection part 23 formed at a lower part thereof to be fixed to the center hole 111 of the sensor body 11, a fastening part 21 formed at an upper part of the connection part 23 having an outer screw thread 21A to be fastened to the seat rail through engagement with nuts, and a supporting flange 22 integrally formed between the fastening part 21 and the connection part 23 to support a lower part of the seat rail.

The connection part 23 is inserted in the center hole 111 of the sensor body 11 and then connected with the center hole 111, for example, by a general brazing process that is used in bonding metal by melting an alloy having a low melting point. Otherwise, the bolt shaft 2 may be integrally formed within the center hole 111.

Here, if the bolt shaft 2 is formed integrally with the center hole 111 of the sensor body 11, tilting and eccentricity of the bolt shaft 2 can be minimized compared to when connecting the connection part 23 of the bolt shaft 2 to the center hole 111 by brazing. However, the manufacturing process is complicated, accordingly increasing the cost price.

To this end, it is more recommended that the connection part 23 of the bolt shaft 2 is connected to the center hole 111 through spin welding, which is advantageous not only in minimizing the tilting and eccentricity of the bolt shaft 2, but also in complete inspection of the strength and the welding state of the product.

Thus, when the vertical bolt shaft 2 is mounted in the center hole 111 of the sensor body, and the fastening part 21 formed with the outer screw thread 21A is fastened to the seat rail using nuts in order to mount the sensor body 11 to the seat rail, the supporting flange 22 of the bolt shaft 2 is brought into close contact with a lower part of the seat rail, keeping a gap with respect to the sensor body 11. Therefore, the supporting flange 22 is able to primarily absorb all the fastening force of the nuts regardless of variation of the fastening force and, accordingly, only a vertical weight load of the seat rail of the vehicle can be transmitted to the diaphragm 11 mounted in the sensor body 11.

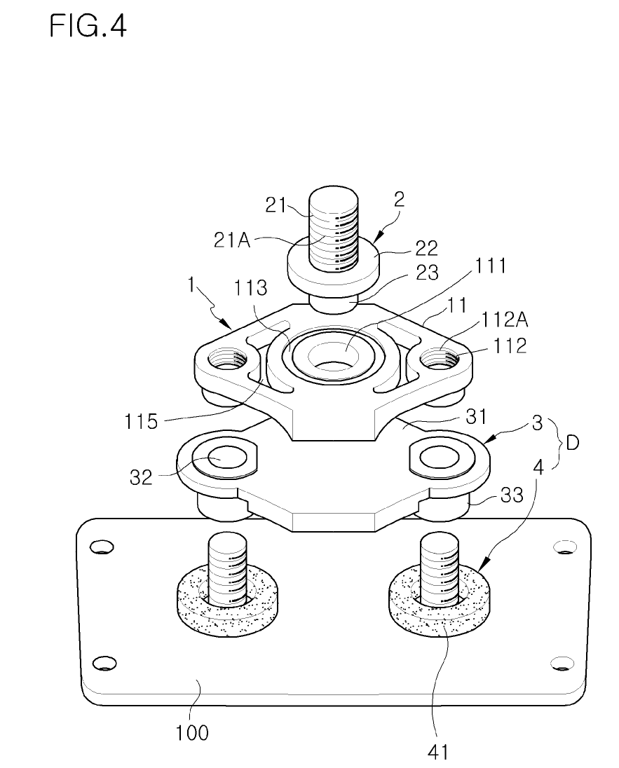

FIG. 3 and FIG. 4 show a passenger weight detection device according to a second embodiment of the present invention, which includes a sensor unit 1. In the same manner as in the first embodiment, the diaphragm 113 is formed at the outside of the center hole 111 of the sensor body 11 so that the semiconductor strain gauge 12 can detect the upper vertical load. Also, the bolt shaft 2 is vertically formed in the center hole 111 of the sensor body 11 so that the sensor body 11 can be fastened to the seat rail by nuts. The passenger weight detection device further includes a damper unit D for absorbing and interrupting miscellaneous loads being transmitted to the diaphragm 113 of the center hole 111 through the fixing holes 112 of the sensor body 11 fastened to the seat frame 100 by bolts.

The sensor unit 1, as general, includes the sensor body 11 structured in such a manner that the diaphragm 113 is formed at the outside of the center hole 111 and the fixing holes 112, each having the inner screw thread 112A, are formed at both sides of the center hole 111. In the sensor body 11, the cutaway part 115 is further formed between a bolt fastening part, that is, the fixing holes 112 and the diaphragm 113.

Since the configuration and the operation of the cutaway part 115 and the bolt shaft 2 are the same as explained with the first embodiment, a detailed description thereof will not be repeated.

The damper unit D includes a first damper 3, fastened to the seat frame 100 of the vehicle together with the sensor unit 1 through a bolt 5 formed at a lower part of the sensor unit 1, and a second damper 4 disposed between the first damper 3 and the seat frame 100.

More specifically, the first damper 3 is constituted by a damper body 31 having a corresponding shape to the sensor body 11 of the sensor unit 1, and bolt fastening holes 32. The bolt fastening holes 32 formed on both sides of the damper body 31 at corresponding positions to the fixing holes 112 of the sensor body 11 to be fastened by the bolt 5 together with the fixing holes 112. In addition, a flange 33 is extended integrally from lower parts of the bolt fastening holes 32.

The second damper 4 includes a damper body 41 made of an elastic material such as rubber and formed with a center hole having a diameter corresponding to a diameter of the flange 33 of the first damper 3 to receive the flange 33 therein. The damper body 41 is fitted into the mounting hole 110 of the seat frame 100. Here, since the mounting hole 110 of the seat frame 100 has a circular shape, the damper body 41 accordingly has an annular form. In addition, the second damper 4 further includes a fixing groove 42 formed along an outer circumference of the damper body 41 to insert the mounting hole 110 of the seat frame 100. Additionally, a washer 6 is formed between the damper body 41 of the second damper 4 and the bolt 5.

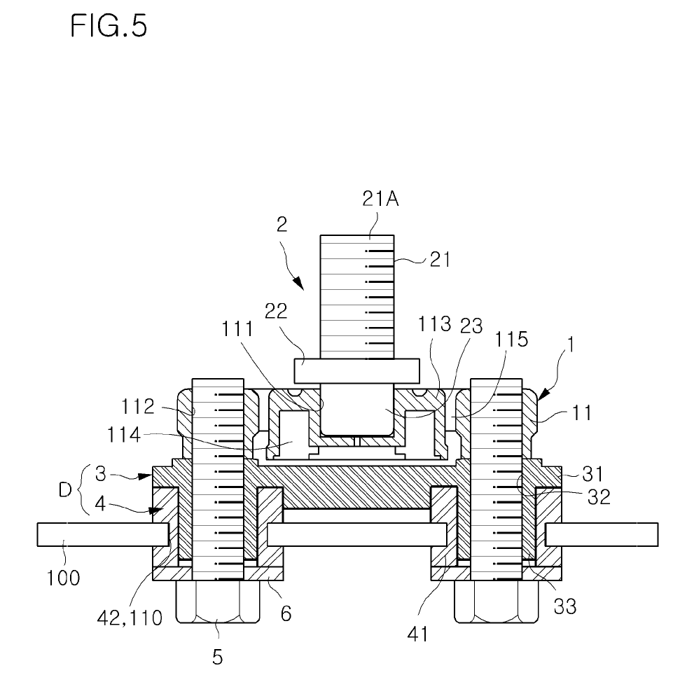

Hereinafter, the assembling process of the passenger weight detection device according to the second embodiment will be described in detail with reference to FIG. 5.

First, the damper body 41 of the second damper 4 is mounted in the mounting hole 110 of the seat frame 100 in such a manner that the mounting hole 110 of the seat frame 100 is inserted in the fixing groove 42 of the second damper 4 that includes the elastic damper body 41.

After the second damper 4 is thus mounted to the mounting hole 110 of the seat frame 100, the flange 33, which is integrally extended downward from the bolt fastening hole 32, is inserted in the damper body 41 of the second damper 4. Next, the sensor body 11 of the sensor unit 1 is disposed on the first damper 3. Here, more specifically, the sensor unit 1 is disposed in such a manner that the fixing holes 112, which are formed on both sides of the sensor body 11, correspond to the bolt fastening holes 32 in the damper body 31 of the first damper 3.

In this state, the bolt 5 is passed through the flange 33 of the first damper 3 damper, from the lower part to the upper part of the flange 33, thereby engaging with the inner screw thread 112A formed in the fixing hole 112 of the sensor unit 1. As a result, the sensor unit 1 and the first damper 3 can be connected to the seat frame 100, which is mounted with the second damper 4.

Next, the fastening part 21 of the bolt shaft 2, which is vertically formed in the center hole 111 of the sensor body 11, is fastened to the seat rail by nuts, thereby completing a series of the assembling processes. The supporting flange 22 is formed at the bolt shaft 2, maintaining a predetermined gap from the sensor body 11. The supporting flange 22 is brought into close contact with the lower part of the seat rail and therefore primarily absorbs all the fastening forces by the nuts, as aforementioned. Accordingly, only the vertical load caused by the weight of the seat rail influences the diaphragm, regardless of the fastening force of the nuts.

As described above, since the second damper 4 made of an elastic rubber is interposed between the seat frame 100 and the flange 33 of the first damper 3, the flange 33 and the seat frame 100 can be maintained out of contact with each other, thereby preventing the miscellaneous loads from being transmitted through the bolt. In addition, the first damper 3 made of metal is able to, by its own strength, compensate for bending of the seat frame 100 and the difference of parallelism between the seat frame 100 and the seat rail disposed above the seat frame 100.

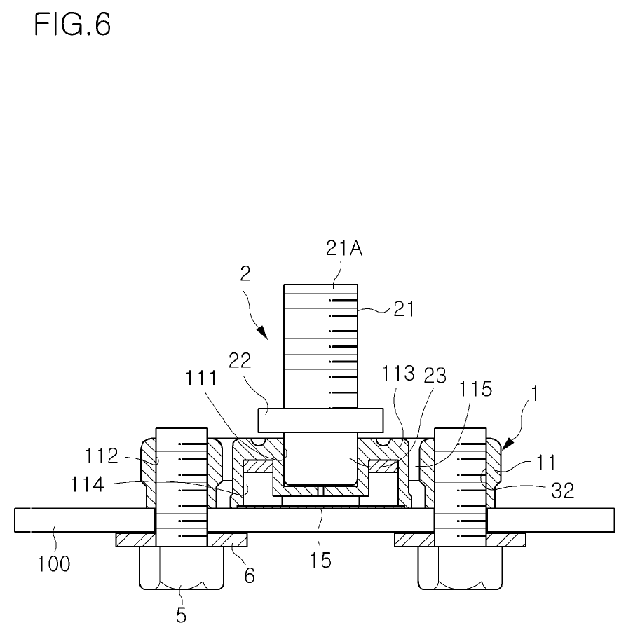

FIG. 6 is a sectional view of a passenger weight detection device according to a third embodiment of the present invention. Referring to the drawing, the connection part 23 of the bolt shaft 2 is connected to the center hole 111 of the sensor body 11 through brazing.

As the cutaway part 115 is formed at the sensor body 11, strength of a bridge 16, that is, the part between the cutaway 115 and each of the fixing holes 112 of the sensor body 11, may deteriorate, thereby causing the miscellaneous loads such as the moment. To this end, an under cover 15 made of metal is provided to finish the exposed outside of the center hole 111 and the mounting recess 114 of the sensor body 11 to minimize the miscellaneous loads.

By thus finishing the center hole 111 and the mounting recess 114 of the sensor body 11 with the under cover 15, strength of the sensor body 11 can be supplemented, consequently preventing generation of the miscellaneous loads. Moreover, dedicated damper members employed in the second embodiment can be omitted, thereby simplifying the structure.

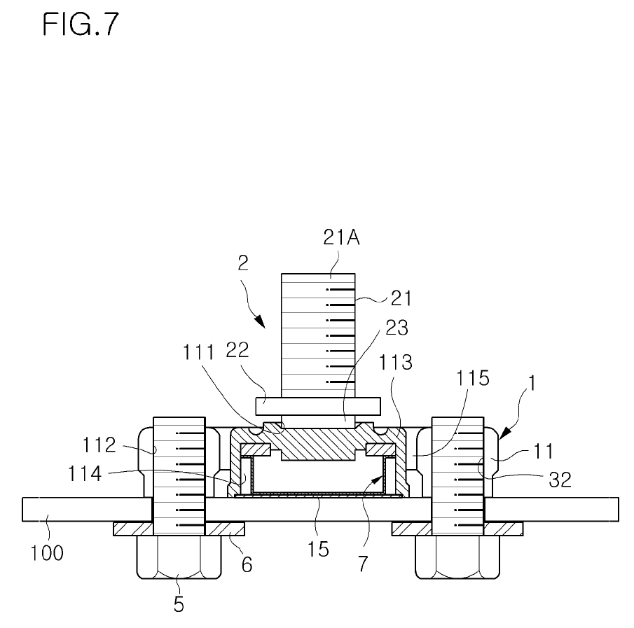

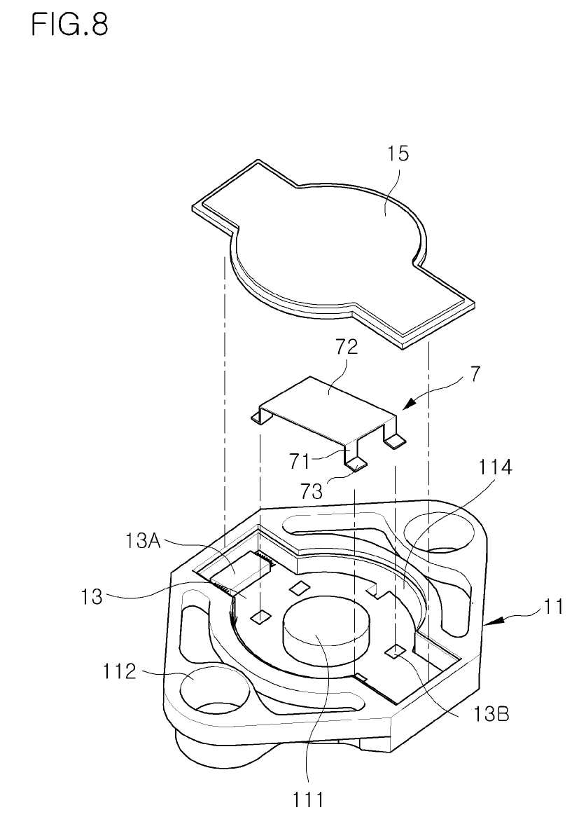

FIG. 7 and FIG. 8 show a passenger weight detection device according to a fourth embodiment of the present invention. More particularly, FIG. 7 is a sectional view and FIG. 8 is an exploded perspective view.

According to the fourth embodiment as shown in the drawings, the connection part 23 of the bolt shaft 2 is bonded to the center hole 111 of the sensor body 11 through spin welding, such that perpendicularity and relevant dimensions of the bolt shaft 2 can be stabilized. Furthermore, since the actual thickness of the diaphragm 113 is increased, the diaphragm 113 can be more flexibly transformed, accordingly improving the accuracy as the sensor unit 1.

Additionally, a holding cover 7 is provided between the PCB 13, built in the mounting recess 114 of the sensor body 11, and the under cover 15. The holding cover 7 is formed as a plate member and made of metal having electric conductivity. More specifically, the holding cover 7 includes a grounding surface 71, contacting the under cover 15, and a plurality of bent pieces 72, which are integrally formed downward from a lower part of the grounding surface 71 and parallel with one another. Each bent piece 72 includes an electric connection part 73 at an end thereof, which is electrically connected to a grounding pad 13B of the PCB 13 by welding.

Here, the electric connection part 73 and the grounding surface 71 are formed rather higher than the part between the PCB 13 and the under cover 15, such that the PCB 13 can be elastically supported by a force for fixing the under cover 15 to the mounting recess 114 of the sensor body 11 while being grounded through the under cover 15 made of metal. As a consequence, grounding of the PCB can be more facilely achieved without dedicated grounding means, accordingly simplifying the structure.

As apparent from the above description, the present invention provides a passenger weight detection device for a vehicle, capable of preventing the fastening force, which is generated when a sensor body is connected to a seat rail of the vehicle, from directly affecting a diaphragm of the sensor body fastened to a seat frame of the vehicle. Further, the passenger weight detection device also assists in preventing a lateral load and other miscellaneous loads, such as moment caused by flatness and bending of a seat frame and difference in parallelism between the seat frame and the seat rail disposed above the seat frame, from directly affecting the diaphragm through fixing holes formed on both sides of the sensor body.

The passenger weight detection device is optimally designed by having a cutaway part disposed between a fixing hole and a center hole to make a long detour of a transmission path of the miscellaneous loads to the diaphragm, such that the miscellaneous loads are not transmitted to the diaphragm mounted to the sensor body through the fixing hole. Therefore, the miscellaneous loads do not influence the direction of detection of a strain gauge formed on the diaphragm. As a consequence, while sensitivity with respect to miscellaneous loads is restricted, predetermined sensitivity can be maintained only to a load exerted in a measurement direction.

In addition, a holding cover made of metal for fixing a PCB is further provided as a shielding member, to achieve connection between a grounding pad of the PCB and the sensor body while preventing movement of the PCB. As a result, the electromagnetic compatibility can be satisfied.

Furthermore, since an under cover made of metal is welded to an exposed lower part of the sensor body in a closing manner, the structural stability and strength can be secured. Accordingly, an additional function of removing the miscellaneous loads can also be secured, while still maintaining the sensitivity with respect to the load exerted in the measurement direction. Therefore, accuracy and reliability of the detection can be improved.

When equipping the center hole of the sensor body with a bolt shaft, the bolt shaft is separately formed. Therefore, tilting or eccentricity of the bolt shaft can be prevented can be prevented while performing friction-welding around the center hole of the sensor body. Accordingly, a desired function equivalent to the design intention can be obtained while reducing the cost. That is, reliability of the device and economic efficiency can be enhanced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A passenger weight detection device for a vehicle, comprising:
a sensor body having a center hole, fixing holes and a mounting recess, each fixing hole being located along a side of the center hole and having an inner screw thread, and the mounting recess being formed at an inside of the sensor body to mount a diaphragm along an outer circumference of the center hole;
a semiconductor strain gauge attached to the diaphragm of the sensor body;
a printed circuit board (PCB) located in the mounting recess and formed at the outside of a flange extended downward from the center hole, thereby being electrically connected with the semiconductor strain gauge;
a semiconductor chip;
a connector electrically connected with the PCB;
a cutaway part formed between the center hole and the respective fixing holes of the sensor body; and
a metal under cover closing exposed parts of the center hole and the mounting recess.

2. The passenger weight detection device according to claim 1, further comprising a holding cover disposed between the PCB and the under cover to enable grounding of the PCB through the under cover while elastically supporting the PCB.

3. The passenger weight detection device according to claim 2, wherein the holding cover comprises a grounding surface which contacts the under cover and a plurality of bent pieces extended downward from a lower part of the grounding surface and parallel with one another; each bent piece includes an electric connection part at an end thereof to be electrically connected to a grounding pad of the PCB by welding.

4. A passenger weight detection device for a vehicle, comprising:
a sensor body having a center hole, fixing holes and a mounting recess, each fixing hole being located along a side of the center hole and having an inner screw thread, and the mounting recess being formed at an inside of the sensor body to mount a diaphragm along an outer circumference of the center hole;
a semiconductor strain gauge attached to the diaphragm of the sensor body;
a printed circuit board (PCB) located in the mounting recess and formed at the outside of a flange extended downward from the center hole, thereby being electrically connected with the semiconductor strain gauge;
a semiconductor chip;
a connector electrically connected with the PCB;
a cutaway part formed between the center hole and the respective fixing holes of the sensor body; and
a bolt shaft having a connection part formed at a lower part thereof to be fixed to the center hole of the sensor body, a fastening part having an outer screw thread and being formed at an upper part of the connection part, and a supporting flange disposed between the fastening part and the connection part, keeping a predetermined gap from the sensor body, to support a lower part of the seat rail.

5. The passenger weight detection device according to claim 4, wherein the sensor body further includes a cutaway part formed between the center hole and the respective fixing holes.

6. The passenger weight detection device according to claim 4, wherein the sensor body further includes an under cover closing an exposed outside of the center hole and the mounting recess.

7. The passenger weight detection device according to claim 6, further comprising a holding cover disposed between the under cover and the PCB to enable grounding of the PCB through the under cover while elastically supporting the PCB.

8. The passenger weight detection device according to claim 7, wherein the holding cover comprises a grounding surface that contacts the under cover and a plurality of bent pieces extended downward from a lower part of the grounding surface and parallel with one another; and
the bent pieces each include an electric connection part at an end thereof to be electrically connected to a grounding pad of the PCB by welding.

9. The passenger weight detection device according to claim 4, wherein the bolt shaft is fixed to the center hole of the sensor body by welding.

10. The passenger weight detection device according to claim 4, wherein the bolt shaft is integrally formed with the center hole.

11. A passenger weight detection device for a vehicle, comprising:
a sensor unit having a diaphragm formed at an outside of a center hole of a sensor body, and fixing holes on two sides such that an upper vertical load can be detected by a semiconductor strain gauge;
a bolt shaft having a connection part formed at a lower part thereof to be fixed to the center hole of the sensor body, a fastening part having an outer screw thread being formed at an upper part of the connection part, and a supporting flange disposed between the fastening part and the connection part, maintaining a predetermined gap from the sensor body, to support a lower part of the seat rail; and
a damper unit provided to absorb and interrupt miscellaneous loads being transmitted to the diaphragm of the center hole through the fixing holes of the sensor body that is fastened to a seat frame by bolts.

12. The passenger weight detection device according to claim 11, wherein the damper unit comprises:
a first damper formed at a lower part of the sensor unit and fastened to the seat frame of the vehicle together with the sensor unit through a bolt; and
a second damper disposed between the first damper and the seat frame.

13. The passenger weight detection device according to claim 12, wherein the first damper comprises a damper body having a corresponding form to the sensor unit; and
the damper body includes bolt fastening holes formed on both sides of the damper body at corresponding positions to the fixing holes of the sensor body and a flange extended integrally from lower parts of the bolt fastening holes.

14. The passenger weight detection device according to claim 12, wherein the second damper comprises a damper body made of elastic rubber and formed as a hollow body to receive the flange of the first damper therein; and
the damper body further includes a fixing groove formed along an outer circumference thereof to insert a mounting hole of the seat frame.

15. The passenger weight detection device according to claim 11, wherein the sensor body further includes a cutaway part formed between the fixing holes and the center hole.

16. The passenger weight detection device according to claim 11, wherein the bolt shaft is fixed to the center hole of the sensor body by welding.

17. The passenger weight detection device according to claim 11, wherein the bolt shaft is integrally formed with the center hole.
